(19) United States
(12) Patent Application Publication
(10) Pub. No.: US 2005/0192205 A1
(43) Pub. Date: Sep. 1, 2005

(54) Multiple use fabric conditioning article with replacement indicium

(76) Inventors: Toan Trinh, Maineville, OH (US); Samuel James Morris III, Cincinnati, OH (US); Lawrence Andrew Schumacher, Trenton, OH (US); Mary Vijayarani Barnabas, West Chester, OH (US); Jacqueline Marie Duderstadt, Cincinnati, OH (US); Bienvenido Alvarez Santos, Cincinnati, OH (US); Charles Michael Hardy, Worwood, OH (US); Shelley Lynn Dauderman, Rising Sun, IN (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/059,100

(22) Filed: Feb. 16, 2005

Related U.S. Application Data
(60) Provisional application No. 60/548,374, filed on Feb. 27, 2004.
(60) Provisional application No. 60/550,555, filed on Mar. 5, 2004.
(60) Provisional application No. 60/550,669, filed on Mar. 5, 2004.
(60) Provisional application No. 60/550,557, filed on Mar. 5, 2004.
(60) Provisional application No. 60/555,860, filed on Mar. 24, 2004.
(60) Provisional application No. 60/555,950, filed on Mar. 24, 2004.
(60) Provisional application No. 60/560,121, filed on Apr. 7, 2004.
(60) Provisional application No. 60/591,032, filed on Jul. 26, 2004.

(51) Int. Cl. C11D 3/00

(52) U.S. Cl. 510/520

(57) ABSTRACT

Replacement indicium for a multiple use fabric conditioning article.

### CROSS-REFERENCE TO RELATED APPLICATIONS

This application claims benefit to the following U.S. Provisional Patent Applications: 60/548,374, filed Feb. 27, 2004; 60/550,555, filed Mar. 5, 2004; 60/550,669, filed Mar. 5, 2004; 60/550,557, filed Mar. 5, 2004; 60/555,860 filed Mar. 24, 2004; 60/555,950 filed Mar. 24, 2004; 60/560,121, filed Apr. 7, 2004; and 60/591,032, filed Jul. 26, 2004, the disclosures of which are all hereby incorporated by reference.

### FIELD OF THE INVENTION

The invention relates to an indicium for a multiple use fabric conditioning composition.

### BACKGROUND OF THE INVENTION

Dryer-added fabric conditioning products provide a better convenience to the consumer as compared to the rinse-added fabric conditioning products because they spare the consumer the requirement of having to be present right at the beginning of the rinse cycle.

There are two main types of dryer-added fabric conditioning products, namely, single use product and multiple-use products. Single use products, most commonly in the sheet form coated with a fabric conditioning composition, calls for adding a single sheet into an automatic clothes dryer containing a wet laundry load, at the beginning of the drying cycle. Examples of this type of product are disclosed in U. S. Pat. No. 3,442,692 to Gaiser and U.S. Pat. No. 3,686,025 to Morton et al.

Multiple use fabric conditioning compositions are placed in the interior of the dryer to release the fabric conditioning active to successive laundry loads. Each multiple-use product lasts many drying cycles, from a few cycles to about 50 or more cycles, and thus provides a better convenience to the consumer than single use products. Said product can either be an unattached article that is added to an automatic clothes dryer and is tumbled along with a wet laundry load, or an article that is releasably attached to the interior of an automatic dryer drum. An example of an unattached multiple use fabric conditioning article is disclosed in U.S. Pat. No. 3,676,199 issued Jul. 11, 1972 to Hewitt et al.

Some unattached multiple use fabric conditioning articles such as those described in U.S. Pat. No. 3,676,199 may have a form-retaining base having a fabric conditioning coating on the exterior thereof which is removable upon contact with tumbling laundry in the dryer, and is transferable to the laundry by such contact. The surface of the base can be porous or rough, or having some indentations therein so that some of the applied fabric conditioning active penetrate below the surface to a sufficient depth to hold the external fabric conditioning coating firmly to the surface during use. After each use, the article is retrieved and examine for wear, and is ready for the next use. A message indicating that the coating of the conditioning active has been removed may be printed onto the foam before coating and is largely obscured by the conditioning composition until that composition is sufficiently removed to warrant replacement of the article.

A preferred example of a releasably attached multiple use fabric conditioning article is disclosed in U.S. Pat. Appl. Publ. No. 2003/0192197 A1 published Oct. 16, 2003 to Griese et al. This patent application discloses a product dispenser system comprising a docking member (referred to as “dispenser”) that is releasably attached to an inner surface of a clothes dryer, a fabric conditioning composition (referred to as “product”) that is attached to a composition carrier (referred to as “product carrier”), wherein said composition carrier is operatively connected to the docking member. The side of the composition carrier that is in contact with the bulk of the solid composition can be flat or have a smooth, arced or dome-like shape. The fabric conditioning composition for use in with this system is disclosed in U.S. Pat. Appl. Publ. No. 2003/0195130 A1 published Oct. 16, 2003 to Lentsch et al. In use, the article is attached to the inside wall of a dryer, such as on a dryer fin, and a wet laundry load is tumbled in the presence of said article while being dried in order to receive the conditioning benefits. After drying, the laundry is removed but the article is left in place and is ready for the next load of wet laundry for drying. This article provides a better convenience than single use products and unattached multiple use products because the consumer does not need to search for the product after each drying cycle. In order to keep the fabric conditioning composition securely fixed to the composition carrier, said carrier comprises recess areas comprising a plurality of apertures, or grooves that are disposed long said composition carrier, with the solid composition extended inside said apertures or grooves, thereby better preventing the solid composition from detaching from said carrier.

This mode of attachment of the solid composition in U.S. Pat. Appl. Publ. No. 2003/0192197 A1 is likely an improvement over the unattached one that is disclosed in U.S. Pat. No. 3,676,199 cited hereinabove. However, this releasably attached multiple use fabric conditioning article has presented the users with an unexpected problem, in that it is difficult for the users to know when to replace the product when it reaches the end of its effective life cycle. First, about 15% or more of the fabric conditioning composition may still be stored in the recess areas of the composition carrier and is not available for fabric conditioning, but is visible to the eyes. Second, since this fabric conditioning article is attached to the inside of the dryer, and thus is not likely routinely examined at close range, and normally placed at a recess area of the drum such as on a dryer fin, and as such, it is likely difficult for the users to tell whether the visible composition is the portion that can be dispensed or not. Third, many users may not be aware that a visible fabric conditioning composition is unavailable for fabric treatment, and thus continue to use the product, even though the product performance becomes minimal. The present invention relates to improvements to solve one or more of these unexpected problems.

### BRIEF DESCRIPTION OF THE DRAWINGS

The invention may take form in various components and arrangements of components, and in various steps and arrangement of steps. The drawings are only for purposes of illustrating the preferred embodiments and are not to be construed as limiting the invention.

FIG. 1 is a perspective view of a multiple use fabric conditioning composition, a composition carrier, an indicium and a docking member;

FIG. 2 is a top view of the composition carrier shown in FIG. 1; and

FIG. 3 is a front view and a side view of the composition carrier shown in FIGS. 1 and 2.

### SUMMARY OF THE INVENTION

A first aspect of the present invention provides for a fabric conditioning article comprising:
(a) a composition carrier;
(b) an indicium; and
(c) a multiple use fabric conditioning composition;
   wherein said article is operably connectable to an inside surface of a dryer.

Another aspect of the present invention provides for a kit comprising:
(a) a fabric conditioning article according to the previously described first aspect of the invention; and
(b) instructions for use thereof.

Another aspect of the present invention provides for a method of conditioning a fabric comprising the step of contacting said fabric with a fabric conditioning article according to the previously described first aspect of the invention.

Another aspect of the present invention provides for a process of making a fabric conditioning article comprising steps:
(a) providing a composition carrier comprising an indicium; and
(b) casting or extruding a multiple use fabric conditioning composition onto said composition carrier.

### DETAILED DESCRIPTION OF THE INVENTION

### DEFINITIONS

“Indicium,” is used herein in the broadest sense, and includes, but is not limited to, a word, phrase, letter, character, brand name, company name, company logo or symbol, description, logo, icon, perfume name, design, designer name, symbol, motif, insignia, figure, mark, signal, color, texture, shape, token, advertisement, or combinations thereof, to indicate to a user the end, or the near end, life cycle of a multiple use, fabric conditioning composition. In a preferred embodiment the indicium is chosen from a word, phrase, brand name, company name, description, perfume name, designer name, advertisement, and combinations thereof, wherein said indicium is preferably in one or more than one language. In another preferred embodiment the indicium is chosen from a word, phrase, brand name, logo, icon, design, symbol, figure, and combinations thereof. The indicium is preferably distinctive and distinguishable from a first side of the composition carrier, therefore the term “indicium,” as used herein, does not include the background pattern (e.g., honeycomb) of the composition carrier.

Given that many household clothes dryers are placed rather low on the floor and have a rather small opening, in order for the users to be able to recognize and understand the message from the indicium, such indicium is preferably of a sufficient size that consumers can recognize the message. Thus, in one embodiment the indicium has a dimension, e.g., a length, of at least about 5 cm, preferably at least 8 cm, more preferably at least about 10 cm, and even more preferably at least about 12 cm; and another dimension, e.g., a width, of at least about 1 cm, preferably at least about 1.5 cm, more preferably at least about 2 cm, and even more preferably at least about 2.5 cm, and yet more preferably at least about 4 cm. In a preferred embodiment the indicium does not have dimensions and/or surface areas that are so large as to cover the surface of the first side of the composition carrier such as to hinder the casting or molding processes of the fabric conditioning composition and/or composition carrier.

In one embodiment, the indicium is an integral part of the composition carrier, preferably cast from the same mold. In order for a user to best recognize the indicium that indicates to the user the end, or the near end, life cycle of a multiple use, fabric conditioning composition, the indicium preferably has a significantly different color than that of the fabric conditioning composition which is typically off-white to yellowish to amber to light brown in color. In one embodiment, the color of the indicium is chosen from red orange, blue, green, and lavender. Each color is preferably defined by the CE 1976 L*a*b* color scale which is recommended by the Commission Internationale de l'Eclairage. The preferred red orange color in the present invention has an “L*” value of at least about 30, preferably at least about 40; an “a*” value of from about 20, from about 30, from about 40, from about 50, to about 90, to about 85, to about 80, to about 70; and a “b*” value of from about 40, from about 45, from about 50, from about 55, to about 85, to about 80, to about 75, to about 70. A non-limiting example of a preferred orange color has an “L*” value of from about 45 to about 65, an “a*” value of from about 20 to about 35, and a “b*” value of from about 40 to about 55. A non-limiting example of a preferred red orange color has an “L*” value of from about 40 to about 60, an “a*” value of from about 55 to about 70, and a “b*” value of from about 45 to about 70. Another non-limiting example of a preferred red orange color has an “L*” value of from about 55 to about 70, an “a*” value of from about 70 to about 85, and a “b*” value of from about 70 to about 85. The preferred blue color has an “L*” value of from about 15, to about 90; an “a*” value of from about −30 to about 25, and a “b*” value of from about −70 to about −10. A non-limiting example of a preferred blue color has an “L*” value of from about 60 to about 80, an “a*” value of from about −10 to about 0, and a “b*” value of from about −35 to about −20. Another non-limiting example of a preferred blue color has an “L*” value of from about 18 to about 30, an “a*” value of from about 10 to about 20, and a “b*” value of from about −55 to about −25. A blue color with an “L*” value of from about 50 to about 60, an “a*” value of from about −35 to about −40, and a “b*” value of from about −15 to about −25 is less preferred. The preferred green color has an “L*” value of from about 40 to about 90; an “a*” value of from about −60 to about −25, and a “b*” value of from about −15 to about 60. A non-limiting example of a preferred green color has an “L*” value of from about 60 to about 80, an “a*” value of from about −60 to about −25, and a “b*” value of from about 25 to about 60. A green color with an “L*” value of from about 30 to about 40, an “a*” value of from about −40 to about −30, and a “b*” value of from about −5 to about −15 is less preferred. The preferred lavender color has an “L*” value of from about 40 to about 80; an “a*” value of from about −5 to about 20, and a “b*” value of from about −35 to about −15.

In one embodiment, the indicium is of the same material as the composition carrier (e.g., high melt point plastic) and is integral with the composition carrier such that composition carrier and indicium are of the same color and are made in one step, e.g., from the same mold. In another embodiment, the indicium is of a different material than the composition carrier. In another embodiment, the indicium comprises a color, texture, or appearance distinct from the rest of the composition carrier such as to draw the attention of the user upon the end, or near the end of the lifecycle of the fabric conditioning composition. In another embodiment, the indicium comprises a different color and is comprised from a different material than the composition carrier. When the indicium comprises a different color and/or is comprised a different material than the composition carrier, the indicium and the composition carrier can be made via, e.g., a co-injection molding or “two-shot injection molding” operation. When the indicium comprises a different color than that of the composition carrier, said composition carrier can either comprise a distinctive color, or optionally comprises an off-white color to make the indicium stand out from an off-white background. In yet another embodiment, the indicium is not fixedly connected to the composition carrier, but is held in contact with the composition carrier by the solid, multiple use fabric conditioning carrier, and becomes detached from the composition carrier upon the multiple use fabric conditioning composition reaching an amount that is near the end of the lifecycle such that there is an insufficient quantity of the composition to hold the indicium in place thereby releasing it into the dryer. Upon release, the user may be informed, e.g., via an instruction for use, of the indicium by observing the indicium amongst the laundry and/or hear the indicium striking the barrel of the dryer while the dryer is in use. Alternatively, the indicium is released into the dryer but is tethered to the composition carrier such that not only is the indicium, upon release, found by the user amongst the laundry and/or heard striking the dryer, but the tether (e.g., string) allows the indicium to be more easily retrieved by the user thereby minimizing the chance the indicium is undesirably lost amongst the laundry.

“Multiple use” means the fabric conditioning composition may be used to deliver a desired amount of fabric conditioning component from the fabric conditioning composition to laundry during at least two cycles for drying laundry, preferably at least about 10 cycles, more preferably at least about 20 cycles, even more preferably at least about 30 cycles, yet more preferably at least about 40 cycles, and again even more preferably at least about 50 cycles, alternatively at least about 60 cycles, before the fabric conditioning composition needs to be replaced.

“Dryer” means any type of clothes dryer that uses heat and agitation to remove water from the laundry. An exemplary dryer includes a tumble-type dryer where the laundry is provided within a rotating drum that causes the laundry to tumble during the operation of the dryer.

“Laundry” refers to any textile or fabric material, e.g., garment, that is laundered.

“Fabric conditioning composition” means a composition that comprises a fabric conditioning component and a carrier component that is preferably substantially solid (e.g., gel), more preferably solid, at room temperature (e.g., at about 23° C.). The fabric conditioning component provides fabric conditioning properties to laundry such as fabric softening or antistatic. The fabric conditioning component refers to any substance known in the art that is dispensed to laundry in the dryer that imparts a desired property. Other fabric conditioning components and other optional ingredients may include one or more of: sanitizer, deodorizer, odor control agent, soil repellant, soil release agent, dye-transfer inhibitor, dye fixative agent, chlorine scavenging agent, chelant, fiber protecting polymer, fiber smoother, antimicrobial agent, fungicide, antioxidant, preservative, insect repellent, moth repellent, UV light absorber, optical brightener, wrinkle control agent, processing agent, and/or mold release agent.

The carrier component mixes with the fabric conditioning component and helps the fabric conditioning component resist transfer to laundry by melting during the drying operation. The carrier component is chosen so that the fabric conditioning composition exhibits a melting point or softening point that is above the operating temperature of the dryer. In most dryer operations, this means that the melting temperature of the fabric conditioning composition is above about 90° C. The melting temperature or the softening temperature of the fabric conditioning composition can be above about 95° C., above about 100° C., above about 110° C., or above about 120° C. The melting temperature of the fabric conditioning composition can be below 200° C.

The melting temperature of the fabric conditioning composition refers to the temperature at which the composition begins to flow under its own weight. As the fabric conditioning composition reaches its melting point, one will observe the composition undergoing a transfer from a solid discreet mass to a flowable liquid. Although a differential scanning calorimeter (DSC) measurement of the composition may reveal that certain portions or phases of the composition may exhibit melting at temperatures that are within the operating temperatures of a dryer, it should be understood that what is meant by the melting temperature of the composition is not the melting temperature of certain portions or phases within the composition, but the melting temperature of the composition as demonstrated by the composition being visibly observed as a flowable liquid. It is expected that the fabric conditioning composition may be provided as a solid mixture including multiple phases or as a solid solution including a single phase.

The softening temperature of the composition refers to the temperature at which the solid mass becomes easily deformable. For many exemplary compositions according to the invention, it is expected that the softening temperature will be a few degrees below the melting temperature.

Non-limiting examples of suitable fabric conditioning are described in U.S. 2003/0195130 A1 published Oct. 16, 2003 to Lentsch et al., and any continuation-in-part applications thereof.

“Composition carrier” is defined as an object that is preferably operably connected to a multiple use fabric conditioning composition. The composition carrier can comprise a variety of materials, such as cardboard, metal, or plastic, preferably a high melt point plastic, such as nylon or high impact polypropylene (appreciating that other high melt point plastics known in the art may be used). The composition carrier may be of a variety of sizes, shapes, and thicknesses. In one embodiment, the composition carrier is substantially rectangular in shape. The composition carrier, if made of plastic, may be molded, extruded, or blow molded. In one embodiment, the indicium is integral to said carrier, for example, the indicium is molded, extruded, or blow molded as part of the composition carrier. In one embodiment, the composition carrier comprises a first side. In another embodiment, the first side of said composition carrier is flat or arced. In yet another embodiment, the first side of said composition carrier is neither flat nor arced. An example of a suitable composition carrier is described in U.S. Patent Application Publication 2003/0192197.

The fabric conditioning composition is preferably operably connected to the composition carrier by fixedly casting or fixedly extruding the composition onto the carrier, more preferably fixedly casting or fixedly extruding in such a way that the portion of the composition coming into contact with laundry is located on the first side of the composition carrier. To facilitate this casting or extrusion, the composition carrier may comprise a plurality of apertures to allow molten fabric conditioning composition to better adhere to the composition carrier. In one embodiment, the apertures of the composition carrier comprise hexagonal shapes and are arranged in a nonlinear, honeycomb fashion. In this embodiment, this arrangement of apertures, without wishing to be bond by theory, strengthens the casting or extruding of the fabric conditioning compositions onto the composition carrier thereby preventing the composition from breaking and shearing from the composition carrier. In a preferred embodiment, the plurality of apertures are countersunk on a second side of the composition carrier to allow the solid fabric conditioning composition to be fixedly cast or extruded onto said composition carrier. In another embodiment, the first side of the composition carrier comprises a plurality of grooves, wherein grooves are dove tail shaped and disposed along the composition carrier, and wherein said plurality of grooves allow the fabric conditioning composition to be fixedly cast or fixedly extruded onto said product carrier. Other non-limiting ways of operably connecting the fabric conditioning composition and composition carrier include the use of: fixedly casting or fixedly extruding the composition into the apertures or the groves of the composition carrier, adhesive, glue, double sided tape (e.g., 3M, part number 4084), VELCRO® or any other suitable hook and loop or reclosable fastener type device, screws, bolts, magnets, or other connecting means known in the art.

The fabric conditioning article is operably connectable to an inside surface of a dryer. In a preferred embodiment, the article further comprises a docking member to operably connect to the inside of a dryer. Other non-limiting ways of operably connecting the article to the inside surface of the dryer includes the use of adhesive, glue, double sided tape (e.g., 3M, part number 4084), VELCRO® or any other suitable hook and loop or reclosable fastener type device, screws, bolts, magnets, or other connecting means known in the art.

In turn, a “docking member” may comprise a first side and/or a second side. The composition and/or composition carrier may be releasably affixed to the first side of the docking member and/or the inside surface of the dryer. In one embodiment the docking member, preferably the first side of the docking member, comprises a connecting member to affix, preferably releasably affix, the composition carrier, preferably the second side of the composition carrier, to the first side of the docking member. In another embodiment, the docking member, preferably the second side of the docking member, comprises a connecting member to affix, preferably releasably affix, the docking member to the inside surface of a dryer. Non-limiting examples of a connecting member include: lips to secure mating members or mating member to secure lips ; hole plug and segment, wherein the segments releasably engage the holes; a securing tap (e.g., “snap tap”); or combinations thereof. An example of a docking member is described in U.S. Patent Application Publication 2003/0192197.

The fabric conditioning article may be operably connected on a fin, door, or barrel of the dryer. Docking member(s) may be angled, relative to the surface of attachment to decrease or increase efficacy.

In one embodiment, the docking member can have the same color as the composition carrier, or, optionally have a different color than the composition carrier, and optionally have an off-white color.

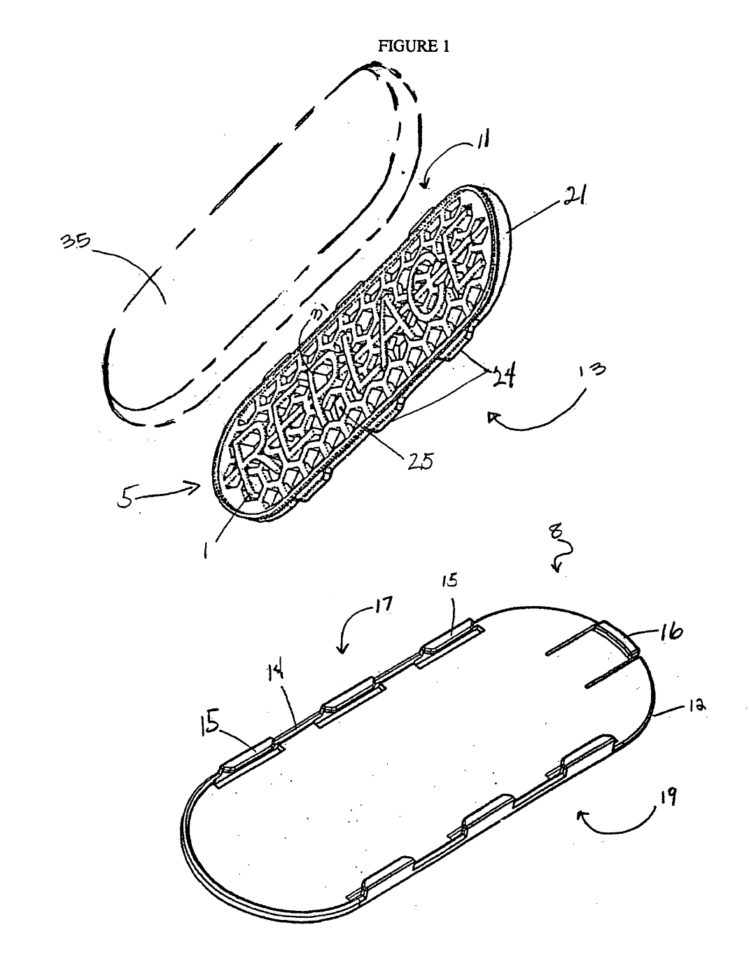

FIG. 1 is a perspective view of a fabric conditioning article comprising a fabric conditioning composition 35, composition carrier 5, and docking member 8. The fabric conditioning composition 35 is represented as a schematic. The composition carrier 5 has a first side 11, a second side 13, and circumferential third edge 21. The fabric conditioning composition 35 is operably connected to the composition carrier 5 by being fixedly cast or fixedly extruded to the composition carrier 5 such that the portion of the composition 35 coming into contact with laundry is located on the first side 11 of the composition carrier. The fabric conditioning composition, can be injected into a mold through a plurality of apertures 25 from the second side 13 of the composition carrier 5. The fabric conditioning composition 35 can be fixedly cast or fixedly extruded into a variety of shapes including those described in FIGS. 16a-19b of US 2003/0192187. The first side 11 of the composition carrier 5 comprises an indicium 1 to indicate to the user to “replace” the fabric conditioning composition 35 and composition carrier 5 upon the composition 35 reaching the end, or near end, life cycle. Lastly, the composition carrier 5 has a circumferential third edge 21 that includes a connecting member in the form of mating members 24 that protrude laterally out.

The indicium 1 may be integral to the composition carrier 5 but is preferably distinctive and distinguishable from the first side 11 of the composition carrier 5 and thus does not include the basic honeycomb pattern of the apertures 25 of the composition carrier 1. The indicium 1 comprises a word or phrase, e.g., the word “REPLACE” in the current embodiment, to indicate to the user to replace the fabric conditioning composition 35. In the present embodiment, the indicium comprises a first side 31 that is elevated from the first side 11 of the composition carrier 5. The first side 31 of the indicium 1 can be flat or have a contoured surface, e.g., arced, that mirrors the surface of the first side 11 of the composition carrier 5, and thus every point on the first side 31 of the indicium 1 has the same elevation away from the surrounding surface of the first side 11 of the composition carrier 5. For aesthetic reasons, it may be desirable in an indicium 1 that has different points on the first side 33 to have different and/or uneven elevations. It is preferable that the indicium 1 does not have sharp edges, comers and/or apexes that can potentially damage the fabrics during drying, but instead has smoothen (e.g., beveled) edges, comers and/or apexes. In another embodiment (not shown in the figures), the first side 31 of the indicium 1 has the same elevation as first side 11 of the composition carrier 5. When the first side 31 of the indicium 1 is elevated from the first side 11 of the composition carrier 5, it is typically elevated from about 0.1 mm to about 5 mm, preferably from about 0.2 mm to about 4 mm, more preferably from about 0.3 mm to about 3 mm, and even more preferably from about 0.4 mm to about 2 mm, from the first side 11 of the composition carrier 5.

In this embodiment, the composition carrier 5 is operably connectable to a docking member 8. The docking member 8 has a first side 17, a second side 19, and a perimeter 12. The second side 19 of the docking member 8 provides a surface onto which an adhesive or another docking member (not shown) or other means of operably connecting the docking member 8 to an inside surface of a dryer. The perimeter 12 of the docking member 8 includes a rail portion 14 bordering the docking member 8 along three sides, which may protect the corresponding three edges of the fabric conditioning composition 35, when the composition 35 is operably connected to the composition carrier 5, and when the composition carrier 5 is operably connected to the docking member 8. The docking member 8 also includes lips 15 and a securing tab 16 as connecting members. The lips 15 extend from the rail portion 14 along two sides. The securing tab 16 is at an end of the docking member 8 not having a rail portion 14. When the composition carrier 5 is slid into the docking member 8 from either end as described below, the securing tab 16 is pushed downward and then snaps into place to border the corresponding edge of the composition carrier 5 when operably connected to the first side 17 of the docking member 8.

The mating members 24 are arranged similarly as the lips 15 on the docking member 8. Therefore, the composition carrier 5 does not have to be slid into the docking member 8 all the way from an end of the composition carrier 5. Rather, the mating member 24 and the corresponding lips 15 are simply placed in the spaces between the lips 15 thereby depressing the securing tab 16 concurrently. As the composition carrier 5 is slid in the docking member 8 so the lips 15 align with the mating members 24, the securing tab 16 engages the end of the composition carrier 5 thereby snap locking it into place. This provides a shorter distance to connect the composition carrier 5 to the docking member 8 should; for example, the walls of the dryer prevent the composition carrier 5 from being slid into place from the end of the docking member 8. To disengage the composition carrier 5 from the docking member 8, the securing tab 16 is pushed downward and then the composition carrier 5 is slid away from the lips 15 of the docking member 8. When the mating members 24 of the composition carrier 5 no longer align with the lips 15 of the docking member 8, the composition carrier 5 may be removed from the docking member 8.

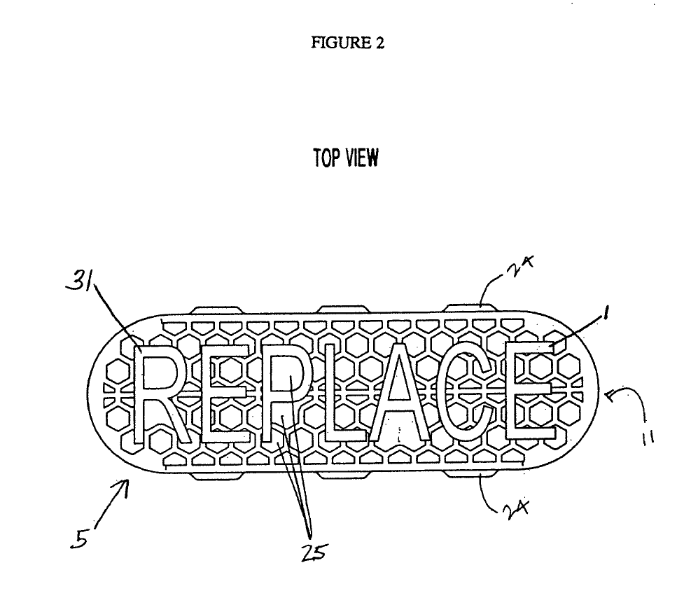

FIG. 2 is a top view of the composition carrier 5. The composition carrier 5 has a plurality of apertures 25; many in a hexagonal “honeycomb pattern.” In one embodiment, the apertures 25 are rounded or beveled (not shown) to prevent laundry from catching on the apertures, at or near the end of the fabric conditioning composition's life cycle, during drying operation. In the current embodiment, six mating members 24 protrude laterally out from the third edge 21. The apertures can provide an “anchoring means” for the fabric conditioning composition. This can be achieved when in a molten state; the composition is injected into a mold through a plurality of apertures 25 from the second side 13 of the composition carrier 5 on to the first side 11 of the composition carrier 5. It can also be achieved when the molten composition is poured into the mold then the composition carrier is placed on top of the molten composition such that the first side 11 of the composition carrier faces the molten composition and such that the molten composition flows through the plurality of apertures 25 from the first side 11 of the composition carrier on to the second side 13 of the composition carrier 5. Although not shown, the apertures 25 are countersunk relative to the second side 13 of the composition carrier 5.

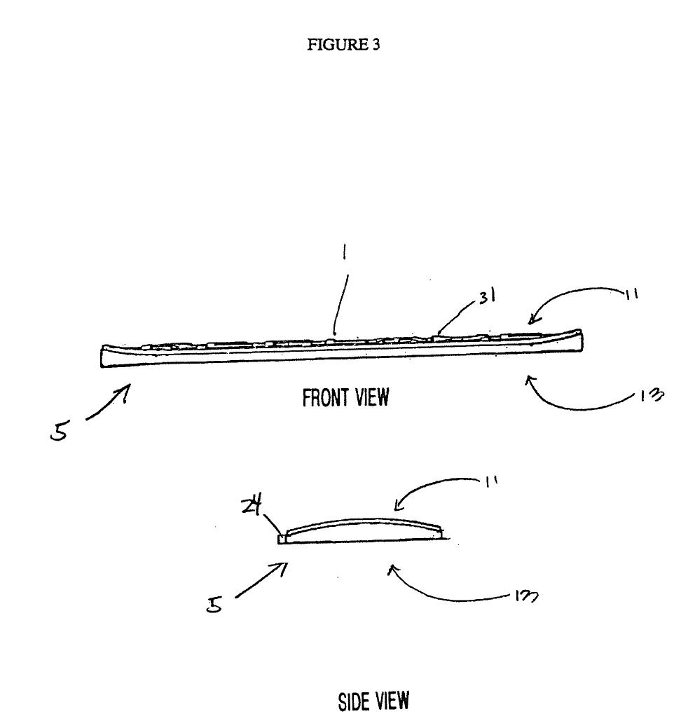

FIG. 3 is a front and side view of composition carrier 6. The first side 11 of the composition carrier 5 can be arced. The indicium 1 comprises a first side 31, which is elevated from the first side 11 of the composition carrier 5.

Kit

Another aspect of the present invention provides for a kit comprising:
(a) a fabric conditioning article of manufacture according to present invention; and
(b) instructions for use thereof.

Since it is difficult to tell when the article ceases to be effective and it is also difficult to read and/or recognize the indicium once the article is installed inside the dryer, it may be important that the article is in association with a set of instructions for use to direct the user when to replace the fabric enhancing composition in order to obtain the best performance. The set of instructions preferably includes an instruction directing the user to observe the indicium and/or an instruction directing the user to replace the product when the indicium reveals itself in its entirety. The set of instructions also preferably includes one or more of the following instruction: an instruction directing the user how to install the docking member, if it is available, onto the interior of the dryer, such as on a fin, an instruction on how to operably connect the composition carrier onto the interior of the dryer or onto the docking member, and combinations thereof. The set of instructions for use can comprise pictures and/or icons. The set of instructions is preferably printed on one or more of: the package, the wrapper, and/or an accompanying instruction flyer or booklet; and/or is communicated via print and/or electronic mass media, more preferably said set of instructions is printed on the package and/or the wrapper, and/or is communicated via print and/or electronic mass media, wherein said mass media is selected from newspapers, magazines, radio, television, internet, and combinations thereof.

In one embodiment, the set of instructions comprises providing a method of conditioning a fabric comprising the step of contacting said fabric with an article of a fabric conditioning article of manufacture according to the previously described first aspect of the invention.

Another aspect of the invention provides for a method of conditioning a fabric comprising the step of contacting the fabric with a fabric conditioning article of the present invention.

The disclosure of all patents, patent applications (and any patents which issue thereon, as well as any corresponding published foreign patent applications), and publications mentioned throughout this Detailed Description are hereby incorporated by reference herein. It is expressly not admitted, however, that any of the documents incorporated by reference herein teach or disclose the present invention.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A fabric conditioning article comprising:
(a) a composition carrier;
(b) an indicium; and
(c) a multiple use fabric conditioning composition;
wherein said article is operably connectable to an inside surface of a dryer.

2. The article of claim 1, wherein said composition carrier comprises a first side, wherein the first side comprises said indicium

3. The article of claim 2, wherein said indicium is chosen from a word, phrase, letter, character, brand name, company name, company logo or symbol, description, logo, icon, perfume name, design, designer name, symbol, motif, insignia, figure, mark, signal, color, texture, shape, token, advertisement, and combinations thereof.

4. The article of claim 3, wherein said indicium is chosen from a word, phrase, brand name, company name, description, perfume name, designer name, advertisement, and combinations thereof, and wherein said indicium is in one or more than one language.

5. The article of claim 3, wherein said multiple use fabric conditioning composition is operably connected to said composition carrier.

6. The article of claim 5, wherein said multiple use comprises at least about 10 cycles.

7. The article of claim 3, wherein said article comprises at least one of adhesive, glue, double sided tape, hook and loop or reclosable fastener type device, screws, bolts, magnets, and combinations thereof, for operably connecting to said inside surface of the dryer.

8. The article of claim 3, further comprising a docking member for operably connecting to said inside surface of the dryer.

9. The article of claim 8, wherein said docking member comprises a first side and a second side, wherein said composition and/or composition carrier is operably connectable to the first side of said docking member, and wherein said second side of the docking member is operably connectable to the inside surface of a dryer.

10. The article of claim 9, wherein said first side of said docking member comprises a connecting member to operably connect said second side of the composition carrier, where said connecting member comprises at least one of a mating member, lip, hole plug, segment, securing tap, or combinations thereof.

11. The article of claim 3, wherein said indicium and said composition carrier comprise the same color and/or are comprised of the same material.

12. The article of claim 3, wherein said indicium comprises a different color and/or is comprised of a different material than the composition carrier.

13. The article of claim 3, wherein said first side of said indicium is elevated from about 0.1 mm to about 5 mm from said first side of said composition carrier.

14. The article of claim 13, wherein said first side of said indicium is flat.

15. The article of claim 13, wherein said first side of said composition carrier is arced, and wherein a first side of said indicium is flat or contours the first side surface of the composition carrier.

16. The article of claim 3, wherein said indicium has a length of at least about 5 cm and a width of at least about 1 cm.

17. The article of claim 16, wherein said indicium has a length of at least about 10 cm and a width of at least about 2 cm.

18. The article of claim 3, wherein said indicium comprises a color, and wherein said color is chosen from red, orange, blue, green, and lavender.

19. The article of claim 18, wherein said composition carrier and said indicium are made of the same material.

20. The article of claim 18, wherein:
(a) said red or orange color is chosen from:
i. an “L*” value of at least about 30, an “a*” value of from about 20 to about 90, and a “b*” value of from about 40 to about 85;
ii. an “L*” value of at least about 40, an “a*” value of from about 30 to about 90, and a “b*” value of from about 40 to about 80;
iii. an “L*” value of from about 40 to about 65, an “a*” value of from about 20 to about 35, and a “b*” value of from about 40 to about 55;
iv. an “L*” value of from about 40 to about 60, an “a*” value of from about 55 to about 70, and a “b*” value of from about 45 to about 70; and
v. an “L*” value of from about 55 to about 70, an “a*” value of from about 70 to about 85, and a “b*” value of from about 70 to about 85;
(b) said blue color is chosen from:
i. an “L*” value of from about 15 to about 90, an “a*” value of from about −30 to about 25, and a “b*” value of from about −70 to about −10;
ii. an “L*” value of from about 60 to about 80, an “a*” value of from about −10 to about 0, and a “b*” value of from about −35 to about −20;
iii. an “L*” value of from about 18 to about 30, an “a*” value of from about 10 to about 20, and a “b*” value of from about −55 to about −25; and
iv. an “L*” value of from about 15 to about 90, an “a*” value of from about −30 to about 25, and a “b*” value of from about −70 to about −10;
(c) said green color is chosen from:
i. an “L*” value of from about 40 to about 90, an “a*” value of from about −60 to about −25, and a “b*” value of from about −15 to about 60; and
ii. an “L*” value of from about 60 to about 80, an “a*” value of from about −60 to about −25, and a “b*” value of from about 25 to about 60; and
(d) said lavender color is an “L*” value of from about 40 to about 80, an “a*” value of from about −5 to about 20, and a “b*” value of from about −35 to about −15.

21. The article of claim 2, wherein the indicium is not connected to the composition carrier.

22. The article of claim 21, further comprising a tether between said indicium and said composition carrier.

23. A method of conditioning a fabric comprising the step of contacting said fabric with a fabric conditioning article according to claim 1.

24. Another aspect of the present invention provides for a kit comprising:
(a) a fabric conditioning article according to claim 1; and
(b) instructions for use thereof.
